(19) United States
(12) Patent Application Publication
(10) Pub. No.: US 2018/0158456 A1
(43) Pub. Date: Jun. 7, 2018

(54) SPEECH RECOGNITION DEVICE AND METHOD THEREOF

(71) Applicant: POSTECH ACADEMY-INDUSTRY FOUNDATION

(72) Inventors: Gary Geunbae LEE, Pohang-si (KR); Hwanjo YU, Pohang-si (KR); Sangdo HAN, Gunpo-si (KR); Seonghan RYU, Seoul (KR); Junhwi CHOI, Seongnam-si (KR)

(21) Appl. No.: 15/721,380

(22) Filed: Sep. 29, 2017

(30) Foreign Application Priority Data
Dec. 1, 2016 (KR) 10-2016-0163022

(51) Int. Cl. G10L 15/22; G10L 15/18

(52) U.S. Cl. CPC G10L 15/22; G10L 15/18

(57) ABSTRACT

A speech recognition device and a method thereof are disclosed. The speech recognition method includes detecting an error word of a recognized received speech, separately encoding a right part and a left part with respect to the detected error word, and decoding while correcting the error word based on a vector of the encoded right and left parts, a last character of the encoded right part, and a last character of the left part.

### CROSS-REFERENCE TO RELATED APPLICATIONS

This application claims priority from Korean Patent Application No. 10-2016-0163022, filed on Dec. 1, 2016, in the Korean Intellectual Property Office, the disclosure of which is incorporated herein by reference in its entirety.

### BACKGROUND OF THE INVENTION

### Field of the Invention

Apparatuses and methods consistent with the present disclosure relate to a speech recognition device and a method thereof, and more particularly, to a speech recognition device and a method thereof, for recognizing speech and correcting error using artificial intelligence (AI).

### Description of the Related Art

Currently, many speech recognition devices have mostly high accuracy but a speech recognition error frequently occurs still. Many application programs using a speech recognition device have been developed but numerous faulty operations are still generated due to a speech recognition error. Many error correction methods have been proposed and, in this regard, models trained based on a corpus including a speech recognition resulting sentence and a correct answer sentence have been mostly proposed.

Conventional methods disadvantageously require a parallel corpus. First, it is difficult to obtain the parallel corpus and a specific corpus depends upon a speech recognition device and a used environment. Accordingly, it is disadvantageously difficult to apply a model trained using a specific corpus when an environment or a speech recognition device is changed. Accordingly, when a new speech recognition device is used, a new speech recognition device needs to re-train a speech recognition model but, when a corpus is regenerated for training, if the corpus is not a speech corpus, there is a difficulty. Accordingly, there is a need for a technology for effectively recognizing speech and correcting an error by using a simulated corpus without a parallel corpus.

### SUMMARY OF THE INVENTION

Exemplary embodiments of the present disclosure overcome the above disadvantages and other disadvantages not described above. Also, the present disclosure is not required to overcome the disadvantages described above, and an exemplary embodiment of the present disclosure may not overcome any of the problems described above.

The present disclosure provides a speech recognition model that is capable of being independently applied to a speech recognition device by encoding and decoding on a character-by-character basis.

The present disclosure provides a speech recognition model for extracting an error word and correcting an error word.

The present disclosure prevents generation of a non-word.

According to an aspect of the present disclosure, a speech recognition method includes detecting an error word of a recognized received speech, separately encoding a right part and a left part with respect to the detected error word, and decoding while correcting the error word based on a vector of the encoded right and left parts, a last character of the encoded right part, and a last character of the left part.

The speech recognition method may further include verifying the corrected error word.

The verifying may include replacing the error word with a space when the corrected error word is a non-word.

The verifying may use a Trie model.

The encoding may include encoding the right part in a backward direction and encoding the left part in a forward direction

The encoding may be performed on a character-by-character basis.

The decoding may include correcting the error word on a character-by-character basis and correcting the error word until a preset end symbol is generated

The encoding and the decoding may use a long-term short-term memory (LSTM) model.

According to another aspect of the present disclosure, a speech recognition device includes a microphone that receives speech, and a processor that recognizes the received speech, wherein the processor detects an error word of a recognized received speech, separately encodes a right part and a left part with respect to the detected error word, and decodes while correcting the error word based on a vector of the encoded right and left parts, a last character of the encoded right part, and a last character of the left part.

The processor may verify the corrected error word.

According to the diverse exemplary embodiments of the present invention, a speech recognition device and a method thereof may provide a speech recognition model that is capable of being independently applied to a speech recognition device by encoding and decoding on a character-by-character basis.

In addition, the speech recognition device and the method thereof may extract an error word and may correct an error word.

The speech recognition device and the method thereof may prevent generation of a non-word.

Additional and/or other aspects and advantages of the invention will be set forth in part in the description which follows and, in part, will be obvious from the description, or may be learned by practice of the invention.

### BRIEF DESCRIPTION OF THE DRAWING FIGURES

The above and/or other aspects of the present disclosure will be more apparent by describing certain exemplary embodiments of the present disclosure with reference to the accompanying drawings, in which:

FIG. 1 is a block diagram of a speech recognition device according to an exemplary embodiment of the present disclosure;

FIG. 2 is a diagram for explanation of a processor according to an exemplary embodiment of the present disclosure;

FIG. 3 is a diagram for explanation of a sequence-based speech recognition error correction model according to an exemplary embodiment of the present disclosure;

FIG. 4 is a diagram for explanation of a Trie search model according to an exemplary embodiment of the present disclosure;

FIG. 5 is a flowchart of a speech recognition method according to an exemplary embodiment of the present disclosure; and

FIG. 6 is a flowchart of a speech recognition method according to another exemplary embodiment of the present disclosure.

### DETAILED DESCRIPTION OF THE EXEMPLARY EMBODIMENTS

Certain exemplary embodiments of the present disclosure will now be described in greater detail with reference to the accompanying drawings. The present disclosure may, however, be embodied in many different forms and should not be construed as being limited to the embodiments set forth herein; rather, these embodiments are provided so that this disclosure will be thorough and complete, and will fully convey the concept of the inventive concept to those of ordinary skill in the art.

It will be understood that, although the terms first, second, third etc. may be used herein to describe various elements, these elements should not be limited by these terms. These terms are only used to distinguish one element from another element.

It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element, such as a layer, a region, or a substrate, is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present.

Throughout the specification, the terms, such as “unit” or “module”, etc., should be understood as a unit that processes at least one function or operation and that may be embodied in a hardware manner, a software manner, or a combination of the hardware manner and the software manner. In addition, a plurality of “modules” or a plurality of “units” may be integrated into at least one module except for a “module” or a “unit” that needs to be embodied as a specific hardware. The plural forms as well, unless the context clearly indicates otherwise.

In the following description of the present disclosure, a detailed description of known functions and configurations incorporated herein will be omitted when it may make the subject matter of the present disclosure unclear.

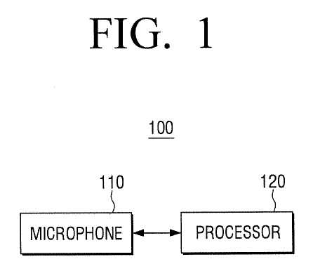

FIG. 1 is a block diagram of a speech recognition device according to an exemplary embodiment of the present disclosure.

Referring to FIG. 1, a speech recognition device 100 may include a microphone 110 and a processor 120. The microphone 110 may receive speech. The microphone 110 may process the received speech to electrical speech data. The speech recognition device 100 may analyze the processed speed data to detect a word containing included in the received speech. The microphone 110 may be implemented with various noise removal algorithms for removing noise generated during a procedure of receiving an external speech signal. Depending on the cases, the speech recognition device 100 may receive speech data that is input and stored through the microphone 110 of an external device.

The processor 120 may recognize the received speech. The processor 120 may detect an error word of the recognized received speech and may correct the detected error word by using an error word correction algorithm. For example, the received speech may be recognized through artificial intelligence (AI). The processor 120 may learn numerous words and sentences by using a deep learning method of AI. The processor 120 may recognize the received speech based on learning experience. A technology for recognizing received speech is well known and is not core feature and, thus, a detailed description thereof will be omitted herein.

As described above, the processor 120 may learn numerous words and sentences by using a deep learning method of AI. For example, the processor 120 may learn that “I have an apple.” is a correct sentence and that “I have a apple.” and “I have and apple.” are incorrect sentences. The processor 120 may learn numerous related sentences and so on. The processor 120 may learn a sentence structure, similarity of a sentence and a word, and relations of a sentence and a word through deep learning. Through the aforementioned procedure, the processor 120 may detect error in a learned sentence and may detect error in a sentence even if the sentence is not learned as long as the sentence has similarity and relations. The processor 120 may verify the corrected error word by using a corrected word verification algorithm. The error word correction method and the corrected word verification method will be described below in detail.

The speech recognition device 100 may further include a memory (not shown) or an output interface (not shown).

The memory may store a program of the error word correction algorithm and the corrected word verification algorithm. The processor 120 may fetch the error word correction algorithm or corrected word verification algorithm stored in the memory from the memory as necessary. The processor 120 may perform an error word correction or corrected word verification function according to the algorithm fetched from the memory. The memory may store a plurality of application programs driven by the speech recognition device 100, data for an operation of the speech recognition device 100, and commands.

For example, the memory may include a storage medium such as a flash memory type memory, a hard disk type memory, a solid state drive (SSD) type memory, a silicon disk drive (SDD) type memory, a multimedia card micro type memory, and a card type memory (e.g., a secure digital (SD) or extreme digital (XD) memory) and, in a broad sense, the memory may include a random-access memory (RAM), a static random access memory (SRAM), read-only memory (ROM), and so on.

The output interface may be used to generate an output related to visual or auditory sense and may output speech data, an error word of which is corrected, or speech data, an error word of which is verified. For example, the output interface may include a display, a speaker, or the like. The display may visually output speech data and the speaker may auditorily output speech data. The display may auditorily output speech data. The display may constitute an interlayer structure with a touch sensor or may be integrated with the touch sensor to be implemented with a touchscreen. The touchscreen may provide an input interface between the speech recognition device 100 and a user and, simultaneously may provide an output interface.

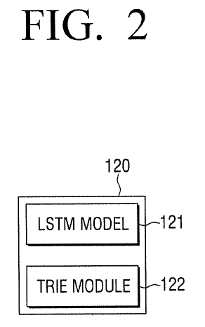

FIG. 2 is a diagram for explanation of a processor according to an exemplary embodiment of the present disclosure.

Referring to FIG. 2, the processor 120 may include a long-term short-term memory (LSTM) module 121 and a Trie module 122. According to an exemplary embodiment of the present disclosure, the error word correction algorithm may be an LSTM algorithm and the corrected word verification algorithm may be a Trie algorithm. As described above, the memory may store a program of an error word correction algorithm and a program of a corrected word verification algorithm. The processor 120 may fetch the error word correction algorithm or the corrected word verification algorithm from the memory. According to an exemplary embodiment, the error word correction algorithm may be an LSTM algorithm and the corrected word verification algorithm may be a Trie algorithm. Accordingly, the LSTM module 121 may be a module that fetches the error word correction algorithm and performs an error word correction function and the Trie module 122 may be a module that fetches the corrected word verification algorithm and performs a corrected word verification function. The LSTM module 121 and the Trie module 122 may be embodied in a hardware manner or a software manner.

An LSTM model and a Trie model are widely used models. In general, natural language data is sequential data and, thus, a recurrent neural network (RNN)-based method that is effective in sequential data may be applied. However, as a sequence is increased, an advantageous effect of a simple RNN may be weakened and a time required for learning is increased. Accordingly, recently, an LSTM or gated recurrent unit (GRU) model has frequently been applied. However, there is a problem in that this model applies word level approach. That is, there is a problem in terms of model training in that this model applies word level approach and a dimension of an input vector is a vocabulary size. To overcome the problem in that a dimension of an input vector is a vocabulary size, various methods are developed but the dimension of the input vector is still a word level.

According to the present disclosure, character level approach may be applied instead of a word level approach. Accordingly, according to the present disclosure, a sequence generation framework using an RNN-based method may be applied to generate a word on a character-by-character basis. A correction result of a speech recognition error needs to be an existent word. However, sequence generation to which an RNN-based method is applied may generate an invalid sequence result, that is, a non-word. To overcome the problem in terms of a non-word, the present disclosure may prevent generation of an invalid sequence result while using the sequence generation to which the RNN-based method is applied. That is, the present disclosure may an effective error word correction procedure and corrected word verification procedure.

Hereinafter, the error word correction procedure and the corrected word verification procedure will be described in detail.

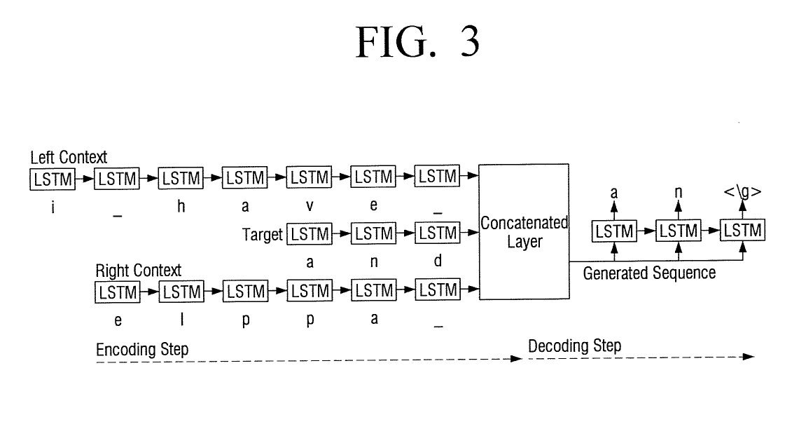

FIG. 3 is a diagram for explanation of a sequence-based speech recognition error correction model according to an exemplary embodiment of the present disclosure.

FIG. 3 illustrates multi sequence-based generation model using an LSTM network. The present disclosure may include an encoding operation and a decoding operation. According to an exemplary embodiment of the present disclosure, in the encoding operation, a target word, and left and right parts of the target word may be encoded in one vector. The target word may refer to a word in which an error occurs. For example, the speech recognition device may receive a sentence “I have an apple”. However, the speech recognition device may wrongly recognize “an”. For example, the speech recognition device may recognize “an” as “and”. That is, the speech recognition device may recognize the current sentence as a sentence “I have and apple”. The speech recognition device may recognize “and” as an error word by virtue of deep learning. A method of recognizing an error word is well known and is not related to the present disclosure and, thus, a detailed description thereof will be omitted herein.

As described above, according to the present disclosure, encoding may be performed on a character-by-character basis. In addition, the speech recognition device may separate a right part and a left part based on the target word. That is, as shown in FIG. 3, the left part may be “I have”, the target word may be “and”, and the right part may be “apple”. In FIG. 3, “_” may refer to a space. The speech recognition device may encode the left part in a forward direction and may encode the right part in a backward direction. The target word may be “and”, a character of a left part close to the target word may be “e”, and a character of a right part close to the target word may be “a”. A character close to the target word is important and, thus, the speech recognition device may encode the left part in a forward direction and may encode the right part in a backward direction.

When a last character of each sequence is encoded, the speech recognition device may concatenate each generated vector to generate one vector and may perform a decoding operation using the generated vector as an input. In the decoding operation, the speech recognition device may generate a new character based on the vector generated during encoding and an immediately previous output character. The speech recognition device may correct an error word on a character-by-character basis. The speech recognition device may correct an error word until a preset end symbol is generated. For example, the speech recognition device may repeatedly generate a new character until </g> as a generation end symbol is generated. When the speech recognition device generates a first character, an immediately previous output character as an input may use a zero vector. When the generation end symbol is generated, the speech recognition device may change an output result to a target word to complete correction.

The LSTM model may correct an error word through training with deep learning. The LSTM model may be trained based on data obtained by intentionally inserting an error into a specific word based on a complete sentence without an error and then correcting the inserted error to a correct answer.

Accordingly, as shown in FIG. 3, the LSTM model may correct the target word. However, in the aforementioned method, an invalid sequence result, that is, a non-word may be generated. Hereinafter, a procedure for verifying a corrected word will be described.

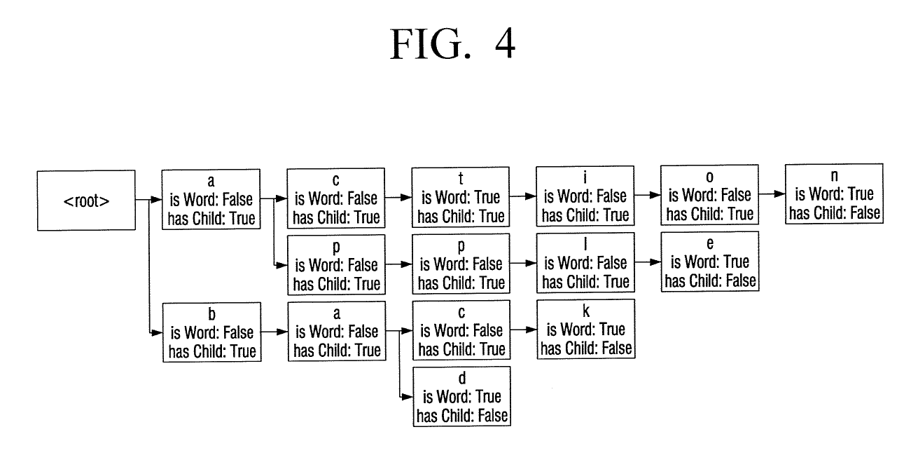

FIG. 4 is a diagram for explanation of a Trie search model according to an exemplary embodiment of the present disclosure.

FIG. 4 illustrates a guidance method using a Trie-based dictionary. The Trie-based dictionary of the speech recognition device may store a word in a character level. The Trie-based dictionary may be configured by concatenating character nodes. A character node of the Trie-based dictionary may include a hasChild parameter and an isWord parameter. When a node has a child node, the hasChild parameter is True. When a node is a last character of a word, the isWord parameter is True.

FIG. 4 shows the Trie-based dictionary that stores word “action”, “action”, “back”, and “bad” according to an exemplary embodiment of the present disclosure. That is, the speech recognition device may determine whether a word is an existent word along a node from a route. For example, when a word as a verification target is “bad”, the speech recognition device may sequentially verify “b”, “a”, and “d” along a node. First, the speech recognition device may verify a node “b” from a route. An isWord parameter of the node “b” is False and a hasChild parameter is True and, thus, a next node may be verified. The speech recognition device may verify an “a” node among next nodes. An isWord parameter of the “a” node is False and a hasChild parameter is True and, thus, a next node may be verified. The speech recognition device may a “d” node among next nodes. An isWord parameter of a “d” node is True and a hasChild parameter is False and, thus, “d” may be recognized as end of a word. Accordingly, the speech recognition device may recognize that “bad” is an existent word. That is, the speech recognition device may verify the corrected error word using the Trie-based dictionary. When the corrected error word is a non-word, the speech recognition device may replace an error word with a space.

According to the aforementioned various embodiments, the speech recognition device may correct an error word on a character-by-character basis and may verify the corrected error word. Hereinafter, a flowchart of a speech recognition method will be described.

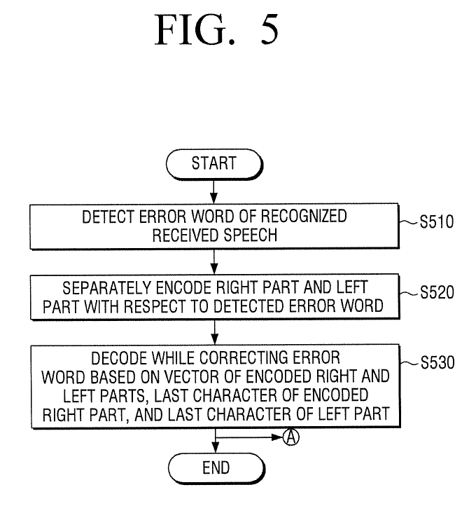

FIG. 5 is a flowchart of a speech recognition method according to an exemplary embodiment of the present disclosure.

Referring to FIG. 5, the speech recognition device may detect an error word of recognized received speech (S510). The speech recognition device may include a microphone and may receive speech through the microphone. In addition, the speech recognition device may receive speech input through a microphone of another device.

The speech recognition device may separately encode a right part and a left part with respect to the detected error word (S520). The error word may be referred to as a target word. The speech recognition device may encode the left part of the target word in a forward direction and may encode the right part of the target word in a backward direction. The speech recognition device may perform encoding on a character-by-character basis.

The speech recognition device may perform decoding while correcting the error word based on a vector of the encoded right and left parts, a last character of the encoded right part, and a last character of the left part (S530). Upon completing encoding of the right and left parts, the speech recognition device may concatenate the right and left parts to generate one vector. The speech recognition device may perform a decoding operation by using the generated vector as an input. In the decoding operation, the speech recognition device may generate a new character based on the vector generated during encoding and an immediately previous output character. The speech recognition device may correct an error word on a character-by-character basis. The speech recognition device may correct an error word until a preset end symbol is generated. The aforementioned error word correction procedure may use an LSTM model.

There is the possibility that the corrected error word is a non-word. Accordingly, the speech recognition device may verify a corrected word.

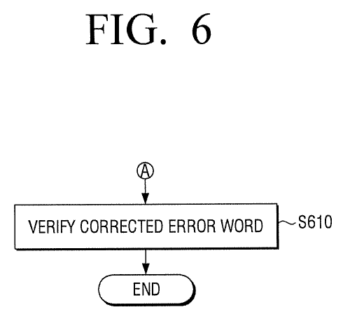

FIG. 6 is a flowchart of a speech recognition method according to another exemplary embodiment of the present disclosure.

Referring to FIG. 6, the speech recognition device may verify a corrected error word (S610). A previous procedure for verifying the corrected error word is the same as in FIG. 5 and, thus, a description thereof is omitted herein. The speech recognition device may use a Trie model. That is, the speech recognition device may verify whether a word is an existent word on a character-by-character basis using the Trie-based dictionary. When the corrected error word is a non-word, the speech recognition device may replace the error word with a space.

A non-transitory computer readable medium for recording thereon a program for sequentially performing the speech recognition method according to the embodiments of the present disclosure may be provided.

The non-transitory computer readable medium is a medium that semi-permanently stores data and from which data is readable by a device, but not a medium that stores data for a short time, such as register, a cache, a memory, and the like. In detail, the aforementioned various applications or programs may be stored in the non-transitory computer readable medium, for example, a compact disc (CD), a digital versatile disc (DVD), a hard disc, a bluray disc, a universal serial bus (USB), a memory card, a read only memory (ROM), and the like, and may be provided.

The foregoing exemplary embodiments and advantages are merely exemplary and are not to be construed as limiting the present disclosure. The present teaching can be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. A speech recognition method comprising:
detecting an error word of a recognized received speech;
separately encoding a right part and a left part with respect to the detected error word; and
decoding while correcting the error word based on a vector of the encoded right and left parts, a last character of the encoded right part, and a last character of the left part.

2. The speech recognition method as claimed in claim 1, further comprising verifying the corrected error word.

3. The speech recognition method as claimed in claim 2, wherein the verifying includes replacing the error word with a space when the corrected error word is a non-word.

4. The speech recognition method as claimed in claim 2, wherein the verifying uses a Trie model.

5. The speech recognition method as claimed in claim 1, wherein the encoding includes encoding the right part in a backward direction and encoding the left part in a forward direction.

6. The speech recognition method as claimed in claim 1, wherein the encoding is performed on a character-by-character basis.

7. The speech recognition method as claimed in claim 1, wherein the decoding includes correcting the error word on a character-by-character basis and correcting the error word until a preset end symbol is generated.

8. The speech recognition method as claimed in claim 1, wherein the encoding and the decoding use a long-term short-term memory (LSTM) model.

9. A speech recognition device comprising:
a microphone configured to receive speech; and
a processor configured to recognize the received speech,
wherein the processor detects an error word of a recognized received speech, separately encodes a right part and a left part with respect to the detected error word, and decodes while correcting the error word based on a vector of the encoded right and left parts, a last character of the encoded right part, and a last character of the left part.

10. The speech recognition device as claimed in claim 9, wherein the processor verifies the corrected error word.
